(19) United States
(12) Patent Application Publication
(10) Pub. No.: US 2021/0323567 A1
(43) Pub. Date: Oct. 21, 2021

(54) VEHICLE CONTROL SYSTEM

(71) Applicant: Mazda Motor Corporation, Hiroshima (JP)

(72) Inventors: Akira KAINO, Aki-gun (JP); Yoshitaka FUJIHARA, Aki-gun (JP)

(73) Assignee: Mazda Motor Corporation, Hiroshima (JP)

(21) Appl. No.: 17/203,764

(22) Filed: Mar. 17, 2021

(30) Foreign Application Priority Data
Apr. 17, 2020 (JP) 2020-074226

(51) Int. Cl. B60W 50/14; B60K 35/00

(52) U.S. Cl. CPC B60W 50/14; B60K 35/00; B60K 2370/334; B60K 2370/1529; B60W 2050/146

(57) ABSTRACT

A vehicle control system has an in-vehicle camera that monitors a state of the driver; a meter device provided in front of a driver's seat; a center display provided at a substantially central position in a vehicle width direction; and a controller that executes automatic stop control when the driver abnormality is determined. The controller does not cause the meter device to show options for selecting execution or discontinuation of the automatic stop control by operating a center console operation device, but causes the meter device to at least show information that notifies of the driver abnormality and/or that notifies of the execution of the automatic stop control. Meanwhile, the controller causes the center display to at least show information having content similar to the information shown on the meter device, and causes the center display to show the options for selecting execution or discontinuation of the automatic stop control.

### CROSS-REFERENCE TO RELATED APPLICATION

The present application claims priority to Japanese App. No. 2020-074226 filed Apr. 17, 2020, the entire content and disclosure of which is incorporated by reference herein in its entirety.

### TECHNICAL FIELD

Embodiments of the present disclosure relate to a vehicle control system that can automatically stop a vehicle emergently when abnormality occurs to a driver during travel.

### BACKGROUND ART

Patent document 1 describes a technique of alleviating a confusion of a driver that is caused in association with timing of activation or cancellation of an automatic stop by displaying information on a situation of an activation determination of the automatic stop or information on a situation of a cancellation determination thereof in the case where the automatic stop is executed. In addition, this Patent document 1 describes that a required operation for the activation or the cancellation of the automatic stop is displayed. Patent document 2 describes that a switch used to initiate or cancel the automatic stop is displayed on a touchscreen. Patent document 3 describes that notification is made to cause an occupant other than the driver to recognize that the automatic stop is currently executed.

### PRIOR ART DOCUMENTS

### Patent Documents

[Patent document 1] JP-A-2018-79707

[Patent document 2] JP-A-2019-43365

[Patent document 3] WO 2013/008300

### SUMMARY

A vehicle control system for a vehicle can comprise: a driver monitoring device that monitors a state of a driver; a first display device that is provided in front of a first seat for the driver and shows first specified information; a second display device that is provided at a position in front of the seat for the driver and a second seat for a passenger and substantially central in a vehicle width direction and that shows second specified information; and a controller configured to execute automatic stop control to automatically stop the vehicle emergently in a case where driver abnormality is determined based on the state of the driver monitored by the driver monitoring device and to execute control to cause the first and second display devices to show information regarding the automatic stop control. The second display device can show options to select execution or discontinuation of the automatic stop control. The vehicle control system can further comprise an input device that accepts input to select one of the options shown on the second display device from an occupant including the driver. The controller can be configured to: execute the automatic stop control in a case where the input device accepts the input to select the execution of the automatic stop control, and discontinue the automatic stop control in a case where the input device accepts the input to select the discontinuation of the automatic stop control; and cause the first display device not to show the options but at least show information that notifies of the driver abnormality and/or information that notifies of the execution of the automatic stop control, and cause the second display device to at least show information having content at least a portion of which is the same as or related to the information shown on the first display device and show the options.

### BRIEF DESCRIPTION OF THE DRAWINGS

FIG. 1 is a schematic view illustrating a cabin space of a vehicle, to which a vehicle control system according to one or more embodiments of the present disclosure is applied.

FIG. 2 is a block diagram illustrating a schematic configuration of the vehicle control system according to one or more embodiments of the present disclosure.

FIG. 3 is a flowchart illustrating automatic stop control according to one or more embodiments of the present disclosure.

FIGS. 4A-4C illustrate screen examples that may be shown when driver abnormality occurs in one or more embodiments of the present disclosure.

FIGS. 5A-5C illustrate screen examples that may be shown when selection of canceling the automatic stop control is made in one or more embodiments of the present disclosure.

FIGS. 6A-6C illustrate screen examples that may be shown during automatic travel in the automatic stop control in one or more embodiments of the present disclosure.

FIGS. 7A-7C illustrate screen examples that may be shown during a lane change in one or more embodiments of the present disclosure.

FIGS. 8A-8C illustrate screen examples that may be shown when the vehicle is about to be stopped in one or more embodiments of the present disclosure.

FIGS. 9A-9C illustrate screen examples that may be shown when the vehicle is stopped in one or more embodiments of the present disclosure.

### DETAILED DESCRIPTION

A description will hereinafter be made on a vehicle control system according to an embodiment of the present invention with reference to the accompanying drawings.

By the way, in the case where abnormality occurs to the driver, and the automatic stop is thereby executed, there is a possibility that the automatic stop is discontinued mistakenly due to an erroneous operation by the driver whose judgment is impaired. In order to prevent such a possibility, it is considered that a display, an operation, and the like related to the discontinuation of the automatic stop are desirably configured in such a manner that an occupant other than the driver can carefully watch operation for discontinuing the automatic stop by the driver.

One or more embodiments of the present disclosure have been made to solve the above-described problem and additional problems, and, therefore, can have a purpose, of one or more purposes, of providing a vehicle control system capable of appropriately preventing a driver from discontinuing an automatic stop mistakenly in the case where abnormality occurs to the driver and the automatic stop is executed.

In order to achieve the above purpose and additional purposes, one or more embodiments of the present disclosure can provide a vehicle control system that has: a driver monitoring device that monitors a state of a driver; a first display device that is provided in front of a driver's seat and shows specified information; a second display device that is provided at a position in front of the driver's seat and a passenger's seat and substantially central in a vehicle width direction and that shows specified information; and a controller configured to execute automatic stop control for automatically stopping a vehicle emergently in the case where driver abnormality is determined on the basis of the driver state monitored by the driver monitoring device and to execute control for causing the first and second display devices to show information on the automatic stop control. The second display device can show options for selecting execution or discontinuation of the automatic stop control. The vehicle control system can further include an input device that accepts input for selecting the option shown on the second display device from an occupant including the driver. The controller can be configured to execute the automatic stop control in the case where the input device accepts the input for selecting the execution of the automatic stop control and to discontinue the automatic stop control in the case where the input device accepts the input for selecting the discontinuation of the automatic stop control. In addition, the controller can be configured to cause the first display device not to show the options but at least show information that notifies of the driver abnormality and/or information that notifies of the execution of the automatic stop control and to cause the second display device to at least show information having a similar content to the information shown on the first display device and show the options.

In one or more embodiments of the present disclosure, the controller may not cause the first display device to show the options for selecting the execution or the discontinuation of the automatic stop control according to the input to the input device, but can cause the first display device to at least show the information that notifies of the driver abnormality and/or the information that notifies of the execution of the automatic stop control. Meanwhile, the controller can cause the second display device to at least show the information having the similar content to the information shown on the first display device, and causes the second display device to show the options for selecting the execution or the discontinuation of the automatic stop control.

That is, in one or more embodiments of the present disclosure, the second display device, which can show the information at the substantially central position in the vehicle width direction, can show the option for selecting the discontinuation of the automatic stop control, so as to allow the occupant other than the driver (particularly, the occupant on the passenger's seat) to reliably and visually recognize such an option. In this way, the occupant other than the driver can carefully watch operation for discontinuing the automatic stop by the driver. Therefore, it can be possible to appropriately prevent the automatic stop from being discontinued mistakenly due to an erroneous operation by the driver whose judgment is impaired.

Meanwhile, in one or more embodiments of the present disclosure, the controller can cause the first display device, which can show the information at the position in front of the driver's seat, to show the information that notifies of the driver abnormality and/or the information that notifies of the execution of the automatic stop control, that is, causes the first display device to show minimum information on a current situation. In this way, the driver whose consciousness is impaired can comprehend the current situation intuitively, and thus the driver can be given a sense of safety. In addition, since the controller also can cause the second display device to show such information, the occupant other than the driver can also be given the sense of safety.

In one or more embodiments of the present disclosure, the controller can be configured to cause the second display device to show information on another vehicle that exists around the vehicle in the case where the automatic stop control is executed.

Thus, according to one or more embodiments of the present disclosure, it can be possible to notify the occupant that the vehicle currently executes the automatic stop control while appropriately comprehending a surrounding situation, and it can thus be possible to give the occupant the sense of safety in regard to the automatic stop control.

In one or more embodiments of the present disclosure, the controller can be configured to cause the second display device to at least show operation of the vehicle that is performed during the automatic stop control.

Thus, according to one or more embodiments of the present disclosure, it can be possible to notify the occupant of the operation (behavior) of the vehicle during the automatic stop control, and it can thus be possible to give the occupant the sense of safety.

In one or more embodiments of the present disclosure, the input device can be provided at a substantially central position in the vehicle width direction and can be constructed of an operation device that can be operated by the occupant including the driver.

Thus, according to one or more embodiments of the present disclosure, the occupant other than the driver can carefully watch the operation for discontinuing the automatic stop by the driver. Therefore, it can be possible to further reliably prevent the driver from discontinuing the automatic stop mistakenly.

In one or more embodiments of the present disclosure, the first display device can be constructed of a meter device and/or a head-up display.

According to the vehicle control system according to one or more embodiments of the present disclosure, it can be possible to appropriately prevent the driver from discontinuing the automatic stop mistakenly in the case where the abnormality occurs to the driver and the automatic stop is performed.

### [Configuration of Vehicle Control System]

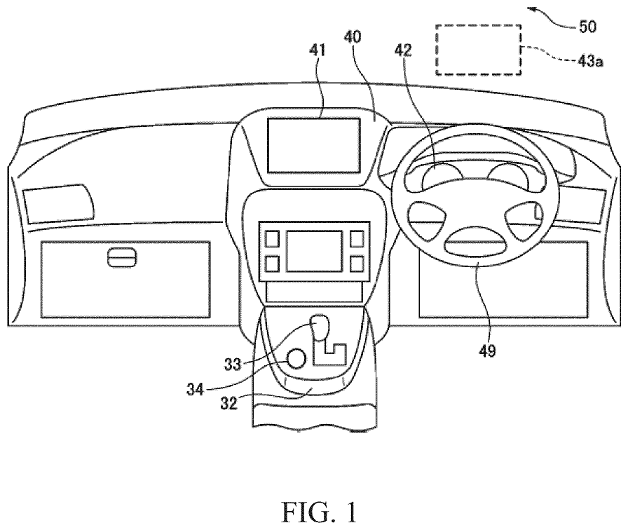

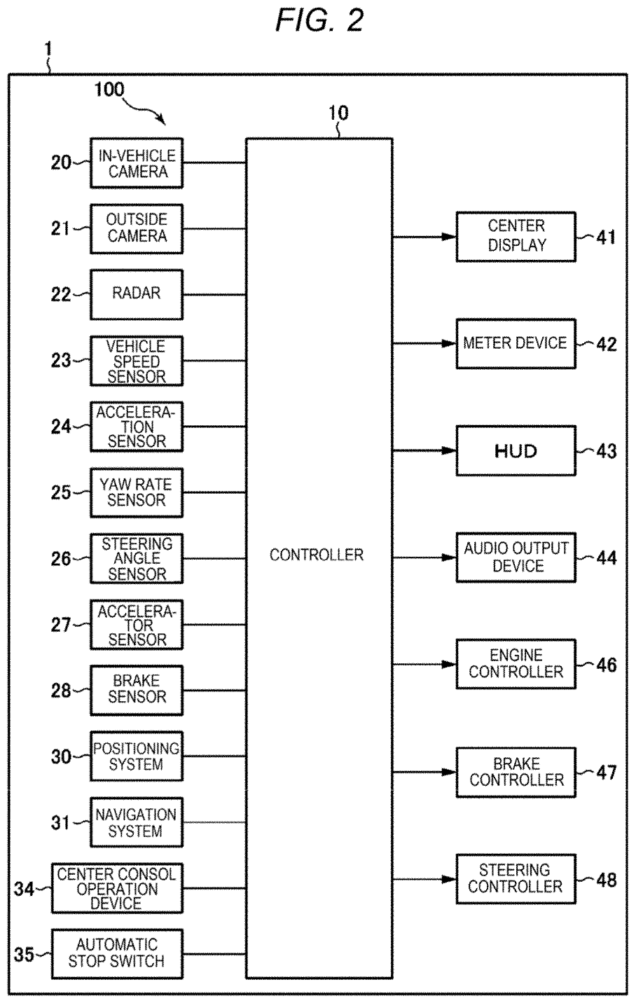

First, a description will be made on a configuration of a vehicle control system according to one or more embodiments of the present disclosure with reference to FIG. 1 and FIG. 2. FIG. 1 is a schematic view illustrating a cabin space of a vehicle, to which the vehicle control system according to the one or more embodiments of the present disclosure can be applied. FIG. 2 is a block diagram illustrating a schematic configuration of the vehicle control system according to the one or more embodiments of the present disclosure.

As illustrated in FIG. 1, in a cabin, an instrument panel 40, a center console 32, and the like are provided in a cabin. In the instrument panel 40, a center display 41 and a meter device 42 are mounted. The center display 41 is provided at a position that is in front of a driver's seat and a passenger's seat and is substantially central in a vehicle width direction, and is constructed of a liquid crystal display (LCD). The meter device 42 is provided in front of a steering wheel 49 and includes gauges displaying a speed, an engine speed, a gear range, and the like. The center console 32 is provided with: a range operation device 33 for switching a range of an automatic transmission (not illustrated); and a center console operation device 34 that is operated to select any of various options shown on the center display 41, and the like. In one example, the center console operation device 34 is constructed of a dial-type rotary switch.

In addition, FIG. 1 schematically illustrates an image 43a (in other words, an image area) that is shown on a front windshield 50 by a head-up display (HUD) 43 illustrated in FIG. 2. Strictly speaking, this image 43a corresponds to a virtual image that is projected by the HUD 43 and is visually recognized by a driver via the front windshield 50, and will hereinafter be referred to as an “HUD image.” The device of the HUD 43 itself is mounted in a dashboard, for example.

Next, as illustrated in FIG. 2, a vehicle control system 100 can have: a controller 10 including an electronic control unit (ECU) and the like; plural types of sensors, each of which outputs a specified signal to the controller 10; and plural devices, each of which is controlled by a control signal received from the controller 10. The vehicle control system 100 is configured to execute automatic stop control for automatically stopping a vehicle (hereinafter appropriately referred to as a “host vehicle”) 1 emergently when determining the driver abnormality during travel of the vehicle 1.

More specifically, the plural types of sensors are an in-vehicle camera 20, an outside camera 21, a radar 22, a vehicle speed sensor 23 for detecting behavior of the vehicle 1 and a driving operation by an occupant, an acceleration sensor 24, a yaw rate sensor 25, a steering angle sensor 26, an accelerator sensor 27, and a brake sensor 28. The plural types of sensors further include a positioning system 30 for detecting a position of the vehicle 1, a navigation system 31, the center console operation device 34, and an automatic stop switch 35. The plural devices that are controlled by the controller 10 are the center display 41, the meter device 42, the HUD 43, an audio output device 44, an engine controller 46, a brake controller 47, and a steering controller 48. The controller 10 is constructed of a computer that includes one or more processors (typically CPUs), memory (ROM, RAM, or the like) for storing various programs, an input/output device, and the like.

The in-vehicle camera 20 captures an image of inside of the cabin, in particular, an image of the driver, and outputs image data. The controller 10 analyzes a posture and the like of the driver on the basis of the image data received from the in-vehicle camera 20, and thereby determines whether the driver is abnormal. For example, in the case where the analyzed posture of the driver is a posture that cannot be assumed at the time when the driver normally drives the vehicle 1, the controller 10 determines that the driver is abnormal. The in-vehicle camera 20 corresponds to an example of the “driver monitoring device” in one or more embodiments of the present disclosure.

The outside camera 21 captures an image around the vehicle 1 and outputs image data. Based on the image data received from the outside camera 21, the controller 10 identifies objects (for example, a preceding vehicle (a front vehicle), a following vehicle (a rear vehicle), a parked vehicle, a pedestrian, a travel road, road marking lines (a lane divider, a white line, and a yellow line), a traffic signal, a traffic sign, a stop line, an intersection, an obstacle, and the like). The controller 10 may acquire information on the object from the outside through a traffic infrastructure, inter-vehicle communication, or the like. In this way, a type, a relative position, a moving direction, and the like of the object can be identified.

The radar 22 measures a position and a speed of the object (particularly, the preceding vehicle, the following vehicle, the parked vehicle, the pedestrian, a dropped object on the travel road, or the like). For example, a millimeter-wave radar can be used as the radar 22. The radar 22 transmits a radio wave in an advancing direction of the vehicle 1 and receives a reflected wave that is generated when the object reflects the transmitted wave. Then, based on the transmitted wave and the received wave, the radar 22 measures a distance between the vehicle 1 and the object (for example, an inter-vehicular distance) and a relative speed of the object to the vehicle 1. Instead of such a radar 22, a laser radar, an ultrasonic sensor, or the like may be used to measure the distance from and the relative speed of the object. Alternatively, plural types of sensors may be used to constitute a position and speed measuring device.

Here, based on travel road information and obstacle information that are acquired by the outside camera 21 and the radar 22 described above, the controller 10 can execute automated driving control of the vehicle 1, more specifically, the automatic stop control for automatically stopping the vehicle 1 emergently. For example, the travel road information includes information on a shape of the travel road (a straight road, a curved road, or a curvature of the curved road), a travel road width, the number of lanes, a lane width, regulation information of the travel road designated on the traffic sign or the like (a speed limit or the like), the intersection, a crosswalk, and the like. The obstacle information includes information on presence or absence of the obstacle on the travel road of the vehicle 1 (for example, the object such as the preceding vehicle, the following vehicle, the parked vehicle, or the pedestrian that can possibly be an obstacle in travel of the vehicle 1), a moving direction of the obstacle, a moving speed of the obstacle, and the like.

The vehicle speed sensor 23 detects an absolute speed of the vehicle 1. The acceleration sensor 24 detects acceleration of the vehicle 1. This acceleration includes acceleration in a longitudinal direction and acceleration in a lateral direction (that is, lateral acceleration). The acceleration includes not only a change rate of the speed in a speed increasing direction but also a change rate of the speed in a speed reducing direction (that is, deceleration).

The yaw rate sensor 25 detects a yaw rate of the vehicle 1. The steering angle sensor 26 detects a rotation angle (a steering angle) of steering of the vehicle 1. The controller 10 performs a specified calculation on the basis of the absolute speed, which is detected by the vehicle speed sensor 23, and the steering angle, which is detected by the steering angle sensor 26, and can thereby acquire a yaw angle of the vehicle 1. The accelerator sensor 27 detects an operation of an accelerator pedal by the driver, more specifically, a depression amount of the pedal (an accelerator operation amount). The brake sensor 28 detects an operation of a brake pedal by the driver, more specifically, a depression amount of the pedal.

The positioning system 30 is a GPS system and/or a gyroscopic system, and detects the position of the vehicle 1 (current vehicle position information). The navigation system 31 stores map information therein and can provide the map information to the controller 10. Based on the map information and the current vehicle position information, the controller 10 identifies a road, the intersection, the traffic signal, a building, and the like that exist around (particularly, in the advancing direction of) the vehicle 1. The map information may be stored in the controller 10. The navigation system 31 also acquires the travel road information described above.

The center console operation device 34 is provided in the center console 32 as illustrated in FIG. 1 and is operated to select any of the various options shown on the center display 41, and the like. The automatic stop switch 35 is a switch that is operated to automatically stop the vehicle 1. This automatic stop switch 35 is provided at such a position in the cabin that the driver himself/herself can operate when the driver feels his/her own abnormality.

The center display 41, the meter device 42, and the HUD 43 are as described with reference to FIG. 1. The audio output device 44 is constructed of a speaker that outputs audio to the inside of the cabin, and the like. Here, the center display 41 corresponds to the “second display device” in one or more embodiments of the present disclosure, and the meter device 42 and the HUD 43 each correspond to the “first display device” in one or more embodiments of the present disclosure. The center console operation device 34 corresponds to the “input device” in one or more embodiments of the present disclosure, and the “input device” can accept input for selecting any of the options shown on the center display 41 from the occupant. As the “input device” in one or more embodiments of the present disclosure, one or more embodiments of the present disclosure are not limited to use of an operation device, such as the center console operation device 34, that is operated by the occupant to select the options shown on the center display 41, but may be use of an audio input device (for example, a microphone) with which any of the options shown on the center display 41 is selected by the occupant's voice.

The engine controller 46 controls an engine of the vehicle 1. The engine controller 46 is a component capable of regulating engine output (driving force) and, for example, includes an ignition plug, a fuel injection valve, a throttle valve, a variable valve mechanism that varies opening/closing timing of each of intake and exhaust valves, and the like. When the vehicle 1 has to be accelerated or decelerated, the controller 10 sends the control signal to the engine controller 46 so as to vary the engine output.

The brake controller 47 controls a brake system of the vehicle 1. The brake controller 47 is a component capable of regulating a braking force of the brake system and, for example, includes a hydraulic pump, a valve unit, and the like. When the vehicle 1 has to be decelerated, the controller 10 sends the control signal to the brake controller 47 so as to generate the braking force.

The steering controller 48 controls a steering system of the vehicle 1. The steering controller 48 is a component capable of regulating the steering angle of the vehicle 1 and, for example, includes an electric motor for an electric power steering system, and the like. When the advancing direction of the vehicle 1 has to be changed, the controller 10 sends the control signal to the steering controller 48 so as to change a steering direction.

[Automatic Stop Control]

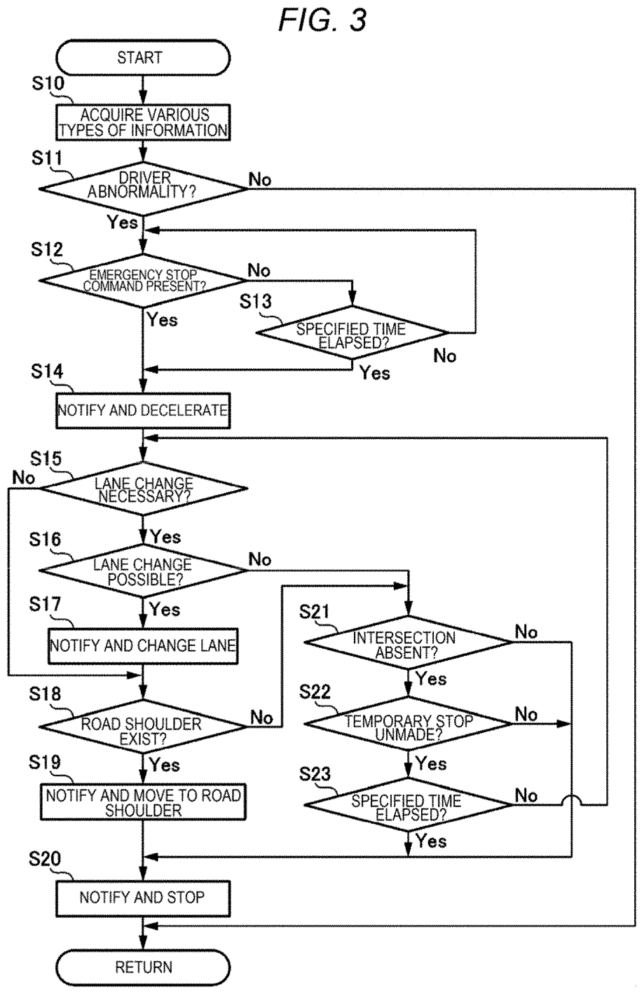

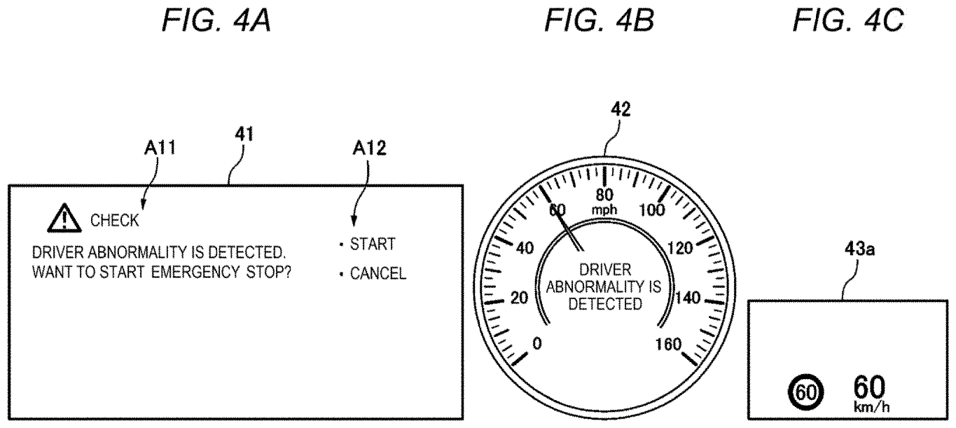

Next, a specific description will be made on the automatic stop control according to one or more embodiments of the present disclosure with reference to FIG. 3 to FIG. 9C. FIG. 3 is a flowchart illustrating automatic stop control according to one or more embodiments of the present disclosure, and FIG. 4A to FIG. 9C each illustrate a screen (or screens or screen portions) that may be shown at respective one of various stages in the automatic stop control according to one or more embodiments of the present disclosure. More specifically, in FIG. 4A to FIG. 9C, Chart (A), i.e., the left-most screen shown in the figures, illustrates information shown by the center display 41, Chart (B), i.e., the center screen shown in the figures, illustrates information shown by the meter device 42, and Chart (C), i.e., the right-most screen shown in the figures, illustrates information shown by the HUD 43, that is, the HUD image 43a. In particular, Chart (B) in each of FIG. 4A to FIG. 9C illustrates only a portion corresponding to a speedometer in the meter device 42. Chart (C) in each of FIG. 4A to FIG. 9C illustrates an example in which only the speed limit and the current vehicle speed are usually shown in the HUD image 43a for convenience of description (in reality, various contents other than these are shown).

Processing related to the flowchart illustrated in FIG. 3 can be repeatedly executed by the controller 10 in specified cycles. First, in step S10, the controller 10 acquires various types of the information from the plural types of sensors illustrated in FIG. 2.

Next, in step S11, the controller 10 determines whether the abnormality occurs to the driver, in other words, determines whether the driver is in a state where it is difficult for the driver to drive the vehicle 1. In a typical example, the controller 10 analyzes the posture of the driver (a posture of the driver's head) on the basis of the image of the driver, which is captured by the in-vehicle camera 20, and determines whether the driver is abnormal. More specifically, in the case where the analyzed posture of the driver is the posture that cannot be assumed at the when the driver normally drives the vehicle 1, the controller 10 determines that the driver is abnormal. In another example, in the case where the steering angle, which is detected by the steering angle sensor 26, is changed in a manner that cannot occur in the normal travel, the controller 10 determines that the driver is abnormal (in this example, the steering angle sensor 26 corresponds to the “driver monitoring device” in one or more embodiments the present disclosure. In further another example, the controller 10 determines whether the driver is abnormal on the basis of a characteristic of saliency of a person. More specifically, in the case where a specified visual stimulus is presented in front of the driver, but a sightline direction of the driver is not appropriately shifted to the visual stimulus, the controller 10 determines that the driver is abnormal. As a result of such step S11, if the abnormality does not occur to the driver (step S11: No), the controller 10 terminates the processing related to the flowchart illustrated in FIG. 3.

On the other hand, if the abnormality occurs to the driver (step S11: Yes), the processing proceeds to step S12. In this case, the controller 10 causes the audio output device 44 to output advanced driver-assistance systems (ADAS) warning sound about three times. In addition, the controller 10 provides a screen as illustrated in FIGS. 4A-4C.

FIGS. 4A-4C illustrate screen examples that may be shown when the driver abnormality occurs in the embodiment of the present invention. In this case, as indicated by a reference sign and symbol A11 in Chart (A), i.e., FIG. 4A, the controller 10 causes the center display 41 to show a message, “CHECK”, that calls attention of the occupant, a message, “DRIVER ABNORMALITY IS DETECTED.”, that notifies of the driver abnormality, and a message, “WANT TO START EMERGENCY STOP?”, that inquires about whether to execute the automatic stop control. In addition, as indicated by Chart (B), i.e., FIG. 4B, the controller 10 causes the meter device 42 to show a message, “DRIVER ABNORMALITY IS DETECTED”. Meanwhile, the controller 10 provides the information that is usually shown in the HUD image 43a. Furthermore, as indicated by a reference sign and symbol A12 in Chart (A), i.e., FIG. 4A, the controller 10 causes the center display 41 to show options to execute or discontinue the automatic stop control. More specifically, the center display 41 shows the options (in other words, a menu) of “START” and “CANCEL” for the automatic stop control. The thus-shown options on the center display 41 can be selected by operating the center console operation device 34. One of the options that is selected by operating the center console operation device 34 is shown in a different mode (for example, a color thereof is changed) from the other option that is not selected. In this way, an operator can distinguish presence or absence of the selection.

Next, in step S12, the controller 10 determines whether a command to execute the automatic stop control (an emergency stop command) is present. In the case where the occupant including the driver selects the option of “START”, which is shown on the center display 41, by operating the center console operation device 34, the controller 10 determines that the emergency stop command is present (step S12: Yes), and the processing proceeds to step S14. On the other hand, if such an emergency stop command is absent (step S12: No), the processing proceeds to step S13. In step S13, the controller 10 determines whether a specified time (for example, approximately three seconds) has elapsed since the driver abnormality is determined. As a result, if the specified time has elapsed (step S13: Yes), the processing proceeds to step S14 even without the emergency stop command. On the other hand, if the specified time has not elapsed (step S13: No), the processing returns to step S12. In this case, the controller 10 repeats the determinations in steps S12, S13 until a lapse of the specified time.

In addition, in the case where the driver operates the automatic stop switch 35, that is, in the case where the driver feels his/her own abnormality and turns on the automatic stop switch 35 to execute the automatic stop control, regardless of the processing in above steps S11 to S13, the controller 10 executes processing in step S14 onward.

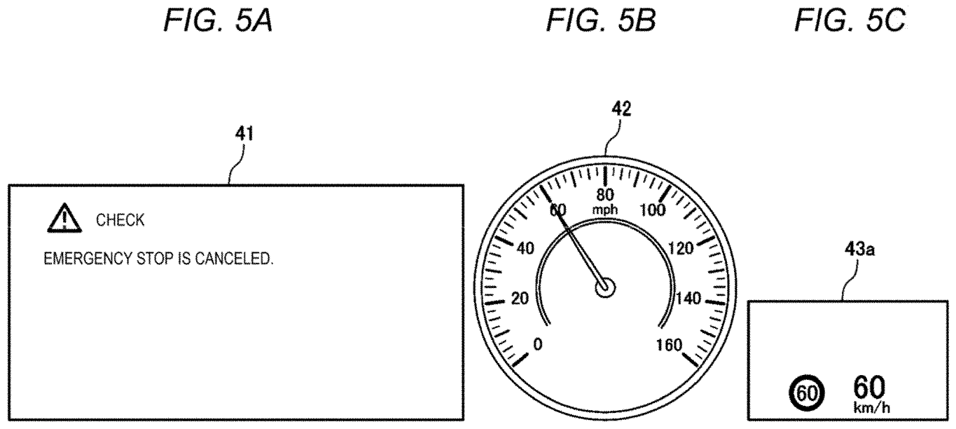

Meanwhile, in the case where the option of “CANCEL”, which is shown on the center display 41, is selected by operating the center console operation device 34, the controller 10 causes the audio output device 44 to output a message, “The vehicle stop by automated travel is cancelled.”, and provides a screen as illustrated in FIGS. 5A-5C. FIGS. 5A-5C illustrate screen examples that may be shown when selection of canceling the automatic stop control is made in one or more embodiments of the present disclosure. In this case, as illustrated in Chart (A), i.e., FIG. 5A, the controller 10 causes the center display 41 to show a message, “EMERGENCY STOP IS CANCELED.”, that notifies of cancellation of the automatic stop control. Meanwhile, the controller 10 provides the information that is usually shown on meter device 42 and the HUD image 43a. This is to make the driver promptly perform normal driving.

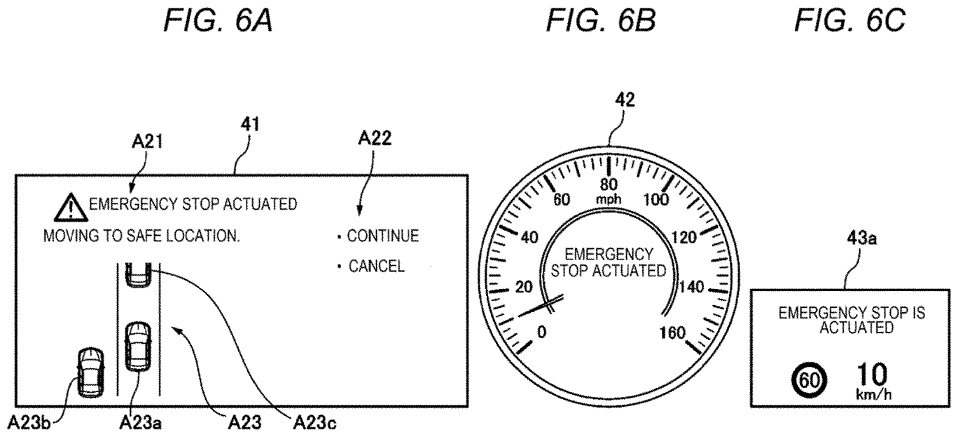

Next, in step S14, the controller 10 initiates the automatic stop control. In this way, the controller 10 automatically stops the vehicle 1 in a safe location within a specified limit time (for example, three minutes). More specifically, in step S14, the controller 10 makes specified notification, and then decelerates the vehicle 1 to approximately 10 km/h. In particular, the controller 10 causes the audio output device 44 to output a message, “The vehicle is automatically stopped in a safe location within three minute.”, and a message, “The vehicle is decelerating to 10 km/h”. In addition, the controller 10 turns on a hazard warning lamp, blows a horn, and blinks a brake lamp in the vehicle 1 to notify vehicles around the vehicle 1 that the vehicle 1 is under the automatic stop control. The controller 10 keeps turning on of the hazard warning lamp, keeps blowing the horn, and keeps blinking the brake lamp, just as described, until the vehicle 1 is finally stopped. Furthermore, the controller 10 provides a screen as illustrated in FIGS. 6A-6C.

FIGS. 6A-6C illustrate screen examples that may be shown during the automatic stop control (that is, during automated travel by the automatic stop control) in the present embodiment of the disclosure. In this case, as indicated by a reference sign and numeral A21 in Chart (A), i.e., FIG. 6A, the controller 10 causes the center display 41 to show messages, “EMERGENCY STOP ACTUATED” and “MOVING TO SAFE LOCATION”. In addition, as illustrated in Chart (B), i.e., FIG. 6B, the controller 10 causes the meter device 42 to show the message, “EMERGENCY STOP ACTUATED”. Furthermore, as illustrated in Chart (C), i.e., FIG. 6C, the controller 10 shows a message, “EMERGENCY STOP IS ACTUATED.”, in the HUD image 43a (such a message may be shown only at initiation of the automatic stop control, and thus such a message may not be shown after the initiation of the automatic stop control). The controller 10 may further cause the center display 41 and the HUD image 43a to present further sensational emergency information.

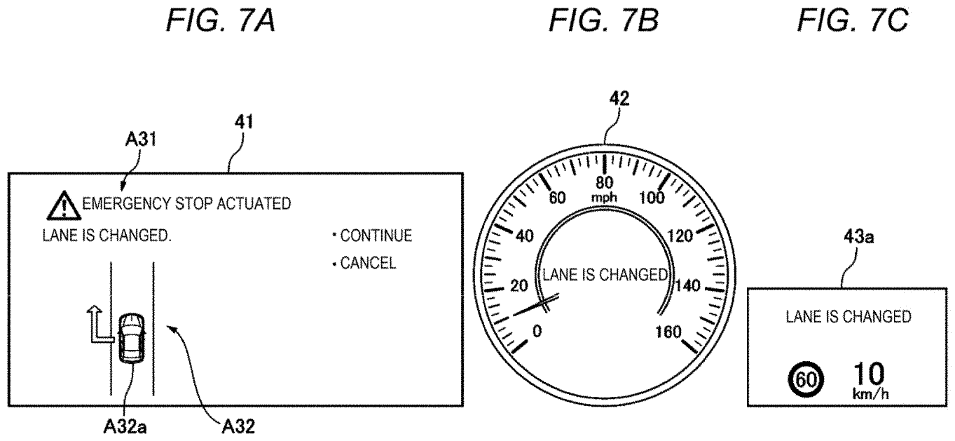

As indicated by a reference sign and symbol A22 in Chart (A), i.e., FIG. 6A, the controller 10 causes the center display 41 to show options of “CONTINUE” and “CANCEL” for the automatic stop control. In the case where the occupant including the driver selects the option of “CANCEL”, which is shown on the center display 41, by operating the center console operation device 34, the controller 10 causes the audio output device 44 to output the message, “The vehicle stop by automated travel is cancelled.”, and provides the screen as illustrated in FIGS. 5A-5C. Such options of “CONTINUE” and “CANCEL” are also shown in screens illustrated in FIG. 7A to FIG. 9C, which will be described below, in a similar manner (hereinafter a description thereon will appropriately be omitted).

Furthermore, as indicated by a reference sign and numeral A23 in Chart (A), i.e., FIG. 6A, the controller 10 causes the center display 41 to show an image A23a of the vehicle (the host vehicle) 1 and images A23b, A23c of other vehicles (peripheral vehicles) around this vehicle 1. In this case, the controller 10 identifies the other vehicles on the basis of the information (the obstacle information) that is acquired by the outside camera 21 and/or the radar 22, and causes the images A23b, A23c of the identified other vehicles to be shown. In particular, the controller 10 causes the images A23b, A23c of the other vehicles to be shown in the form of a video that changes from time to time depending on a situation. When the center display 41 shows the images A23b, A23c of the other vehicles, it is possible to notify the occupant (particularly, the occupant on the passenger's seat) that the host vehicle 1 currently executes the automatic stop control while appropriately comprehending the surrounding situation. In this way, it is possible to give the occupant a sense of safety.

Then, after making such notification including presentation of the images, the controller 10 controls the brake system of the vehicle 1 via the brake controller 47 (may further stop operation of the engine via the engine controller 46), and thereby decelerates the vehicle 1 to approximately 10 km/h.

Next, in step S15, the controller 10 determines whether the vehicle 1 has to change the lane in order to stop the vehicle 1 at the safe location, more specifically, in order to stop the vehicle 1 on a road shoulder. That is, the controller 10 determines whether the lane, in which the vehicle 1 currently travels, (an own lane) is not connected to the road shoulder and thus the vehicle 1 has to be moved to a lane (a left lane) connected to the road shoulder. Basically, in the case where the vehicle 1 travels on a road with one lane in each direction, the own lane is connected to the road shoulder. Thus, the controller 10 determines that a lane change is unnecessary. On the other hand, in the case where the vehicle 1 travels in a lane other than the leftmost lane of a road with two or more lanes in each direction, the own lane is not connected to the road shoulder. Thus, the controller 10 determines that the lane change is necessary. The controller 10 makes such a determination on the basis of the travel road information acquired by the outside camera 21 and the navigation system 31.

As a result of step S15, if the lane change is necessary (step S15: Yes), the processing proceeds to step S16 so as to attempt the lane change. In this case, the controller 10 first causes the audio output device 44 to output a message, “Attempting to change to the left lane”. On the other hand, if the lane change is unnecessary (step S15: No), the lane change does not have to be attempted. Thus, the processing proceeds to step S18 by skipping steps S16, S17.

Next, in step S16, the controller 10 determines whether the lane change can be made. More specifically, the controller 10 calculates a time to collision (TTC) between the peripheral vehicle, which travels on the left lane as a destination, and the vehicle (the host vehicle) 1 on the basis of the obstacle information acquired by the outside camera 21 and/or the radar 22. Then, in the case where this TTC is equal to or longer than a specified value, the controller 10 determines that the lane change can be made. However, in the case where the lane, in which the vehicle 1 travels, is a lane, the lane change from which is prohibited (for example, in the case where the lane divider is a yellow solid line), the controller 10 determines that the lane change cannot be made. As a result of step S16, if the lane change can be made (step S16: Yes), the processing proceeds to step S17. On the other hand, if the lane change cannot be made (step S16: No), the processing proceeds to step S21. In this case, the controller 10 may cause the audio output device 44 to output a message, “The lane change is discontinued”.

Next, in step S17, the controller 10 makes the specified notification and then makes the lane change of the vehicle 1. More specifically, the controller 10 causes the audio output device 44 to output a message, “The lane is changed”. In addition, the controller 10 can provide the screens as illustrated in FIGS. 7A-7C. FIGS. 7A-7C illustrate screen examples that may be shown during the lane change in one or more embodiments of the present disclosure. In this case, as indicated by a reference sign and numeral A31 in Chart (A), i.e., FIG. 7A, the controller 10 causes the center display 41 to show messages, “EMERGENCY STOP ACTUATED” and “LANE IS CHANGED”. In addition, as illustrated in Charts (B), (C), FIG. 7B and FIG. 7C, respectively, the controller 10 causes the meter device 42 and the HUD image 43a to show a message “LANE IS CHANGED”. In addition, as indicated by a reference sign and symbol A32 in Chart (A), i.e., FIG. 7A, the controller 10 causes the center display 41 to show an image A32a of a situation where the vehicle 1 changes the lane. After making the notification including the presentation of the image, the controller 10 executes control to change the steering direction of the vehicle 1 (the steering control) via the steering controller 48, that is, executes control to change the advancing direction of the vehicle 1. In this way, the controller 10 can automatically change the lane of the vehicle 1.

Next, in step S18, the controller 10 determines whether the road shoulder, along which the vehicle 1 can be stopped in the safe location, exists. The controller 10 makes such a determination on the basis of the travel road information, which is acquired by the outside camera 21 and the navigation system 31. In addition, the controller 10 causes the audio output device 44 to output a message, “Searching for a safe location along the road shoulder”. As a result of step S18, if the desired road shoulder exists (step S18: Yes), the processing proceeds to step S19. On the other hand, if the desired road shoulder does not exist (step S18: No), the processing proceeds to step S21. In this case, the controller 10 may cause the audio output device 44 to output a message, “Moving to the road shoulder is discontinued”.

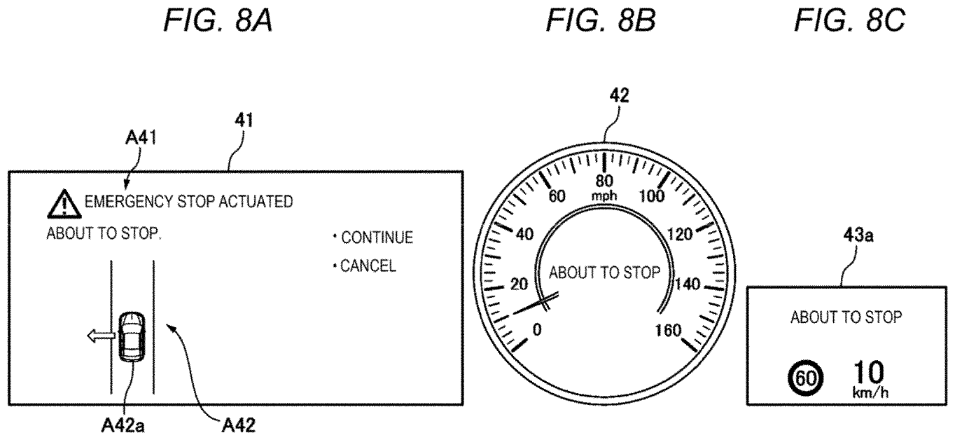

Next, in step S19, the controller 10 makes the specified notification and then moves the vehicle 1 to the road shoulder. More specifically, the controller 10 causes the audio output device 44 to output a message, “Stop in a safe space along the road shoulder”. In addition, the controller 10 can provide the screens as illustrated in FIGS. 8A-8C. FIGS. 8A-8C illustrate screen examples that may be shown when the vehicle 1 is about to be stopped in one or more embodiments of the present disclosure. In this case, as indicated by a reference sign and numeral A41 in Chart (A), i.e., FIG. 8A, the controller 10 causes the center display 41 to show messages, “EMERGENCY STOP ACTUATED” and “ABOUT TO STOP.” In addition, as illustrated in Charts (B), (C), i.e., FIG. 8B and FIG. 8C, respectively, the controller 10 causes the meter device 42 and the HUD image 43a to show the message “ABOUT TO STOP”. Furthermore, as indicated by a reference sign and symbol A42 in Chart (A), i.e., FIG. 8A, the controller 10 causes the center display 41 to show an image A42a of a situation where the vehicle 1 is about to be stopped. After making the notification including the presentation of the image, the controller 10 executes the control to change the steering direction of the vehicle (the steering control) via the steering controller 48, that is, executes the control to change the advancing direction of the vehicle 1. In this way, the controller 10 can move the vehicle 1 to the road shoulder.

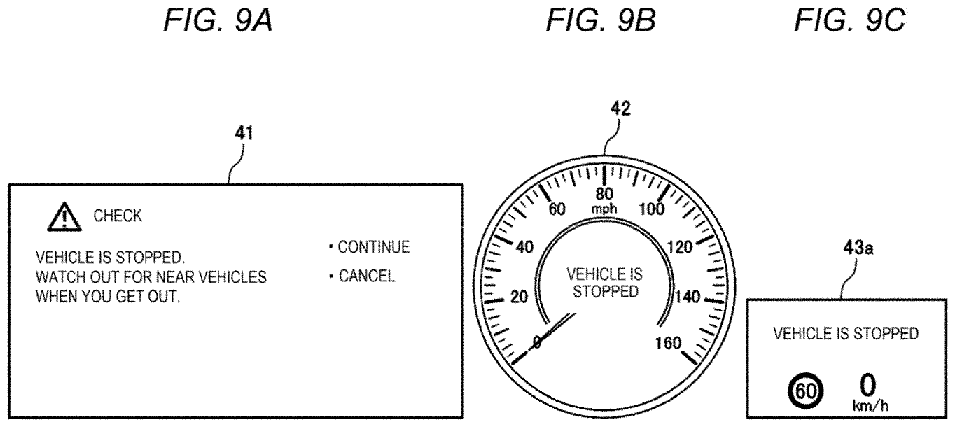

Next, in step S20, the controller 10 makes the specified notification and stops the vehicle 1. More specifically, the controller 10 controls the brake system of the vehicle 1 via the brake controller 47, stops the operation of the engine via the engine controller 46, and thereby stops the vehicle 1. Then, the controller 10 cause the audio output device 44 to output a message, “The vehicle is stopped. Please check the safety around the vehicle when you get out”. In addition, the controller 10 can provide the screens as illustrated in FIGS. 9A-9C. FIGS. 9A-9C illustrate screen examples that may be shown when the vehicle 1 is stopped in one or more embodiments of the present disclosure. In this case, the controller 10 causes the center display 41 to show a message, “VEHICLE IS STOPPED. WATCH OUT FOR NEAR VEHICLES WHEN YOU GET OUT”. In addition, as illustrated in Charts (B), (C), i.e., FIG. 9B and FIG. 9C, respectively, the controller 10 causes the meter device 42 and the HUD image 43a to show a message “VEHICLE IS STOPPED”.

Meanwhile, in step S21, the controller 10 determines whether the intersection is absent ahead of the vehicle 1. The controller 10 makes such a determination on the basis of the travel road information, which is acquired by the outside camera 21 and the navigation system 31. As a result, if the intersection is present (step S21: No), the processing proceeds to step S20. In this case, the controller 10 makes the specified notification and stops the vehicle 1. More specifically, the controller 10 causes the audio output device 44 to output a message, “The vehicle stops before entering the intersection. The vehicle does not start again”. Thereafter, the controller 10 controls the brake system of the vehicle 1 via the brake controller 47, stops the operation of the engine via the engine controller 46, and thereby stops the vehicle 1 before the intersection. Then, the controller 10 cause the audio output device 44 to output the message, “The vehicle is stopped. Please check the safety around the vehicle when you get out”, and shows the screens as illustrated in FIGS. 9A-9C.

On the other hand, as a result of step S21, if the intersection is absent (step S21: Yes), the processing proceeds to step S22. In step S22, the controller 10 determines whether a temporary stop of the vehicle 1 is unmade. More specifically, the controller 10 determines whether the temporary stop of the vehicle 1 is unmade due to the signal, a level crossing, a location where the temporary stop of the vehicle 1 is stipulated by a traffic regulation, heavy traffic, or the like. The controller 10 makes such a determination on the basis of the travel road information, which is acquired by the outside camera 21 and the navigation system 31. As a result, if the vehicle 1 is temporarily stopped (step S22: No), the processing proceeds to step S20. In this case, the controller 10 makes the specified notification and stops the vehicle 1. More specifically, the controller 10 causes the audio output device 44 to output a message, “The vehicle is stopped here. The vehicle does not start again”. Thereafter, the controller 10 controls the brake system of the vehicle 1 via the brake controller 47, stops the operation of the engine via the engine controller 46, and thereby stops the vehicle 1 in a specified location. Then, the controller 10 cause the audio output device 44 to output the message, “The vehicle is stopped. Please check the safety around the vehicle when you get out”, and shows the screen as illustrated in FIGS. 9A-9C.

On the other hand, as a result of step S22, if the temporary stop of the vehicle 1 is unmade (step S22: Yes), the processing proceeds to step S23. In step S23, the controller 10 determines whether a specified time has elapsed since initiation of the processing in step S14, that is, since the automatic stop control is actually initiated. As this specified time, a time that is shorter than the specified limit time (for example, 3 minutes) from the initiation of the automatic stop control to the stop of the vehicle 1 by approximately 10 seconds is applied, for example. As a result of step S23, if the specified time has elapsed (step S23: Yes), the processing proceeds to step S20. In this case, the controller 10 makes the specified notification and stops the vehicle 1. More specifically, the controller 10 causes the audio output device 44 to output a message, “An appropriate evacuation place is unavailable up ahead. The vehicle is promptly stopped from now on”. Thereafter, the controller 10 controls the brake system of the vehicle 1 via the brake controller 47, stops the operation of the engine via the engine controller 46, and thereby stops the vehicle 1 promptly. Then, the controller 10 causes the audio output device 44 to output the message, “The vehicle is stopped. Please check the safety around the vehicle when you get out”, and shows the screens as illustrated in FIGS. 9A-9C. On the other hand, if the specified time has not elapsed (step S23: No), the processing returns to step S15. In this case, the controller 10 repeats the above-described processing (particularly, steps S15 to S18, S21 to S23) until the lapse of the specified time. In this case, the controller 10 repeats the above-described processing (particularly, steps S15 to S18, S21 to S23) until the lapse of the specified time.

### Operation and Effects

Next, a description will be made regarding operation and one or more effects of the vehicle control system according to one or more the embodiments of the present disclosure.

In this embodiment, the controller 10 does not cause the meter device 42 and the HUD 43 to show the options for selecting the execution or the discontinuation of the automatic stop control by operating the center console operation device 34, but can cause the meter device 42 and the HUD 43 to at least show the information that notifies of the driver abnormality and/or the information that notifies of the execution of the automatic stop control. Meanwhile, the controller 10 can cause the center display 41 to at least show the information having the similar content to that of the information shown by the meter device 42 and the HUD 43, and causes the center display 41 to show the options for selecting the execution or the discontinuation of the automatic stop control.

That is, in this embodiment, the center display 41, which is provided at the substantially central position in the vehicle width direction, can show the option for selecting the discontinuation of the automatic stop control, so as to allow the occupant other than the driver (particularly, the occupant on the passenger's seat) to reliably and visually recognize such an option. In this way, the occupant other than the driver can carefully watch the operation for discontinuing the automatic stop by the driver. Therefore, it can be possible to appropriately prevent the automatic stop from being discontinued mistakenly due to an erroneous operation by the driver whose judgment is impaired.

Meanwhile, the controller 10 can cause the meter device 42 and the HUD 43, each of which shows the information at the position in front of the driver's seat, to show the information that notifies of the driver abnormality and/or the information that notifies of the execution of the automatic stop control, that is, can cause the meter device 42 and the HUD 43 to show minimum information on the current situation. In this way, the driver whose consciousness is impaired can comprehend the current situation intuitively, and thus the driver can appropriately be given the sense of safety. In addition, since the controller 10 can also cause the center display 41 to show such information, the occupant other than the driver can also be given the sense of safety.

According to this embodiment, in the case where the automatic stop control is executed, the controller 10 can cause the center display 41 to show the information on the other vehicle that exists around the vehicle 1. Thus, it can be possible to notify the occupant that the vehicle 1 currently executes the automatic stop control while appropriately comprehending the surrounding situation, and it can thus be possible to give the occupant the sense of safety in regard to the automatic stop control.

According to the embodiment, the controller 10 can cause the center display 41 to at least show the operation of the vehicle 1 during the automatic stop control. Thus, it can be possible to notify the occupant of the operation of the vehicle 1 during the automatic stop control, and it can thus be possible to give the occupant the sense of safety.

In this embodiment, it can be configured that the options shown on the center display 41 can be selected by operating the center console operation device 34, which can be provided at the substantially central position in the vehicle width direction. Thus, the occupant other than the driver can carefully watch the operation for discontinuing the automatic stop by the driver. Therefore, it can be possible to further reliably prevent the driver from discontinuing the automatic stop mistakenly.

### Modified Examples

In the embodiment described above, the vehicle 1 can be stopped within the specified limit time since the initiation of the automatic stop control. However, in another example, the vehicle 1 may be stopped before the vehicle 1 passes the specified number (for example, three) of intersections since the initiation of the automatic stop control. In further another example, the vehicle 1 may be stopped before the vehicle 1 travels for a specified distance (for example, 200 m) since the initiation of the automatic stop control.

1. A vehicle control system for a vehicle comprising:
a driver monitoring device that monitors a state of a driver;
a first display device that is provided in front of a first seat for the driver and shows first specified information;
a second display device that is provided at a position in front of the seat for the driver and a second seat for a passenger and substantially central in a vehicle width direction and that shows second specified information; and
a controller configured to execute automatic stop control to automatically stop the vehicle emergently in a case where driver abnormality is determined based on the state of the driver monitored by the driver monitoring device and to execute control to cause the first and second display devices to show information regarding the automatic stop control,
the second display device shows options to select execution or discontinuation of the automatic stop control,
the vehicle control system further comprising:
an input device that accepts input to select one of the options shown on the second display device from an occupant including the driver, wherein
the controller is configured to:
execute the automatic stop control in a case where the input device accepts the input to select the execution of the automatic stop control, and discontinue the automatic stop control in a case where the input device accepts the input to select the discontinuation of the automatic stop control; and
cause the first display device not to show the options but at least show information that notifies of the driver abnormality and/or information that notifies of the execution of the automatic stop control, and cause the second display device to at least show information having content at least a portion of which is the same as or related to the information shown on the first display device and show the options.

2. The vehicle control system according to claim 1, wherein
the controller is configured to cause the second display device to show information regarding another vehicle that exists around the vehicle in the case where the automatic stop control is executed.

3. The vehicle control system according to claim 2, wherein
the controller is configured to cause the second display device to at least show one or more operations of the vehicle performed during the automatic stop control.

4. The vehicle control system according to claim 3, wherein
the input device is provided at a substantially central position in the vehicle width direction and is constructed as an operation device that can be operated by the occupant including the driver.

5. The vehicle control system according to claim 4, wherein
the first display device is constructed as a meter device and/or a head-up display.

6. The vehicle control system according to claim 2, wherein
the controller is configured to cause the second display device to at least show one or more operations of the vehicle performed during the automatic stop control.

7. The vehicle control system according to claim 1, wherein
the input device is provided at a substantially central position in the vehicle width direction and is constructed as an operation device that can be operated by the occupant including the driver.

8. The vehicle control system according to claim 1, wherein
the first display device is constructed as a meter device and/or a head-up display.

9. The vehicle control system according to claim 2, wherein
the input device is provided at a substantially central position in the vehicle width direction and is constructed as an operation device that can be operated by the occupant including the driver.

10. The vehicle control system according to claim 2, wherein
the first display device is constructed as a meter device and/or a head-up display.

11. The vehicle control system according to claim 3, wherein
the first display device is constructed as a meter device and/or a head-up display.

12. The vehicle control system according to claim 6, wherein
the input device is provided at a substantially central position in the vehicle width direction and is constructed as an operation device that can be operated by the occupant including the driver.

13. The vehicle control system according to claim 6, wherein
the first display device is constructed as a meter device and/or a head-up display.

14. The vehicle control system according to claim 7, wherein
the first display device is constructed as a meter device and/or a head-up display.

15. The vehicle control system according to claim 9, wherein
the first display device is constructed as a meter device and/or a head-up display.

16. The vehicle control system according to claim 12, wherein
the first display device is constructed as a meter device and/or a head-up display.
